(19) United States
(12) Patent Application Publication
(10) Pub. No.: US 2024/0289627 A1
(43) Pub. Date: Aug. 29, 2024

(54) METHODS, PROCEDURES, APPARATUSES AND SYSTEMS FOR DATA-DRIVEN WIRELESS TRANSMIT/RECEIVE UNIT SPECIFIC SYMBOL MODULATION

(71) Applicant: INTERDIGITAL PATENT HOLDINGS, INC., Wilmington, DE (US)

(72) Inventors: Ahmet Serdar Tan, London (GB); Onur Sahin, London (GB); Satyanarayana Katla, London (GB)

(21) Appl. No.: 18/573,112

(22) PCT Filed: Jun. 21, 2022
(86) PCT No.: PCT/US2022/034252

§ 371 Date: Dec. 21, 2023

(30) Foreign Application Priority Data
Jun. 21, 2021 (EP) 21180642.7
Mar. 10, 2022 (EP) 22161273.2

(51) Int. Cl. G06N 3/084; G06N 3/0455; H04L 1/00

(52) U.S. Cl. CPC G06N 3/084; G06N 3/0455; H04L 1/0003

(57) ABSTRACT

Procedures, methods, architectures, apparatuses, systems, devices, and computer program products are disclosed are directed to data-driven wireless transmit/receive unit specific symbol modulation. In an embodiment, a method implemented in a wireless transmit/receive unit, WTRU, includes receiving, from a base station, a first transmission comprising a first information indicating one or more parameters. A neural network (NN) is initialized based on the first information. A second transmission is received from the base station and includes a reference signal (RS). The NN is trained based on the RS. A quality indicator (QI) value is computed based on a NN loss of demodulation of the RS. On condition that the QI value satisfies a threshold, the trained NN is deployed for use in connection with demodulating at least one symbol.

### CROSS-REFERENCE TO RELATED APPLICATIONS

This application claims the benefit of European Patent Application No. 21180642.7, filed Jun. 21, 2021; and European Patent Application No. 22161273.2, filed Mar. 10, 2022, each of which is incorporated herein by reference in its entirety.

### TECHNICAL FIELD

The present disclosure is generally directed to the fields of communications, software and encoding, including, for example, to methods, procedures, apparatuses, and systems for data-driven WTRU specific symbol modulation.

### BRIEF SUMMARY

Briefly stated, in one embodiment a method, implemented in a WTRU, includes receiving, from a base station, a first message comprising a set of reference signals and training a neural network based on the first message. A quality indicator value is determined based on a neural network loss of demodulation using the set of reference signals. Based on the quality indicator value satisfying a quality indicator threshold value, the trained neural network is deployed for use in connection with demodulating at least one symbol.

In another embodiment, a method, implemented in a WTRU, includes receiving, from a base station, a first message comprising a first set of reference signals and training a neural network, NN, based on the first message. A first quality indicator value is determined based on a neural network loss of demodulation using the first set of reference signals. Based on the first quality indicator value failing to satisfy a quality indicator threshold value, a second message comprising information indicating the first quality indicator value is transmitted to the base station. A third message is received from the base station comprising a second set of reference signals and the NN is re-trained based on the second set of reference signals. A second quality indicator is determined based on a NN loss of demodulation using the second set of reference signals. Based on the second quality indicator value satisfying the quality indicator threshold value, the re-trained neural network is deployed for use in connection with demodulating at least one symbol.

In another embodiment a WTRU, comprising any of a processor and memory, is configured to receive, from a base station, a first message comprising a set of reference signals and train a neural network based on the first message. A quality indicator value is determined based on a neural network loss of demodulation using the set of reference signals. Based on the quality indicator value satisfying a quality indicator threshold value, the trained neural network is deployed for use in connection with demodulating at least one symbol.

In another embodiment, a WTRU, comprising any of a processor and memory, is configured to receive, from a base station, a first message comprising a first set of reference signals and train a neural network, NN, based on the first message. A first quality indicator value is determined based on a neural network loss of demodulation using the first set of reference signals. Based on the first quality indicator value failing to satisfy a quality indicator threshold value, a second message is transmitted to the base station comprising information indicating the first quality indicator value. A third message is received from the base station comprising a second set of reference signals and the NN is re-trained based on the second set of reference signals. A second quality indicator is determined based on a NN loss of demodulation using the second set of reference signals. Based on the second quality indicator value satisfying the quality indicator threshold value, the re-trained neural network is deployed for use in connection with demodulating at least one symbol.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref”) in the FIGs. indicate like elements, and wherein:

FIG. 1A is a system diagram illustrating an example communication system;

FIG. 1B is a system diagram illustrating an example wireless transmit/receive unit (WTRU) that may be used within the communications system illustrated in FIG. TA;

FIG. 1C is a system diagram illustrating an example radio access network (RAN) and an example core network (CN) that may be used within the communications system illustrated in FIG. TA;

FIG. 1D is a system diagram illustrating a further example RAN and a further example CN that may be used within the communications system illustrated in FIG. TA;

FIG. 2 is a block diagram illustrating an example of function blocks in physical (PHY) layer of a base station and a WTRU;

FIG. 3 is an example of modulation scheme constellations for wireless communication between a base station and a WTRU;

FIG. 4 is a system diagram illustrating an example of an autoencoder neural network;

FIG. 5 is a block diagram illustrating an example of an autoencoder architecture in a physical layer of a base station and a WTRU;

FIG. 6 is a graph illustrating an example of bit error rate (BER) v. signal to noise ratio (SNR) for learned constellations for varying modulation order;

FIG. 7 is a diagram illustrating examples of learned constellations;

FIG. 8 is a block diagram illustrating an example of an end-to-end autoencoder representation in the PHY layer with Neural Networks (NN) structure for symbol modulation/demodulation compared with conventional structure for symbol modulation/demodulation;

FIG. 9 is a diagram illustrating an example of a Scalable NN structure for M-ary symbol modulation;

FIG. 10 is a diagram illustrating an example of a twin autoencoder NN model at transmitter PHY layer for BER v. SNR computations;

FIG. 11 is a flowchart diagram illustrating an example of a method for symbol modulation learning with online training;

FIG. 12 is a signaling diagram illustrating an example of a procedure for a symbol modulation learning between a base station and a WTRU in accordance with the flowchart diagram of FIG. 11;

FIG. 13 is a flowchart diagram illustrating an example of a method for data transmission using data-driven constellation shaper trained for WTRU specific symbol modulation;

FIG. 14 is a procedure diagram illustrating an example of a method for data transmission using data-driven constellation shaper trained for WTRU specific symbol modulation;

FIG. 15 is a representation diagram illustrating an example of training reference signals (TR-RS) and physical downlink shared channel (PDSCH) time multiplexing;

FIG. 16 is a representation diagram illustrating an example of TR-RS and PDSCH frequency multiplexing;

FIG. 17 is a representation diagram illustrating an example of TR-RS and PDSCH time frequency multiplexing;

FIG. 18 is a representation diagram illustrating an example of only TR-RS time frequency multiplexing;

FIG. 19 is a flow chart illustrating an example of a method implemented in a WTRU, for training modulation and coding scheme according to an embodiment; and

FIG. 20 is a flow chart illustrating an example of a method implemented in a WTRU, for training modulation and coding scheme according to another embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

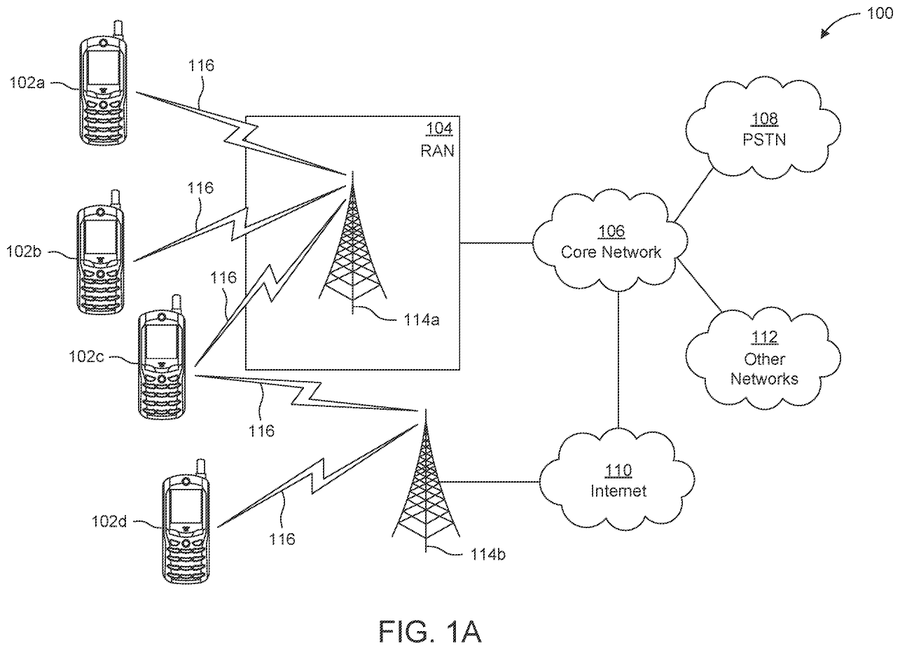

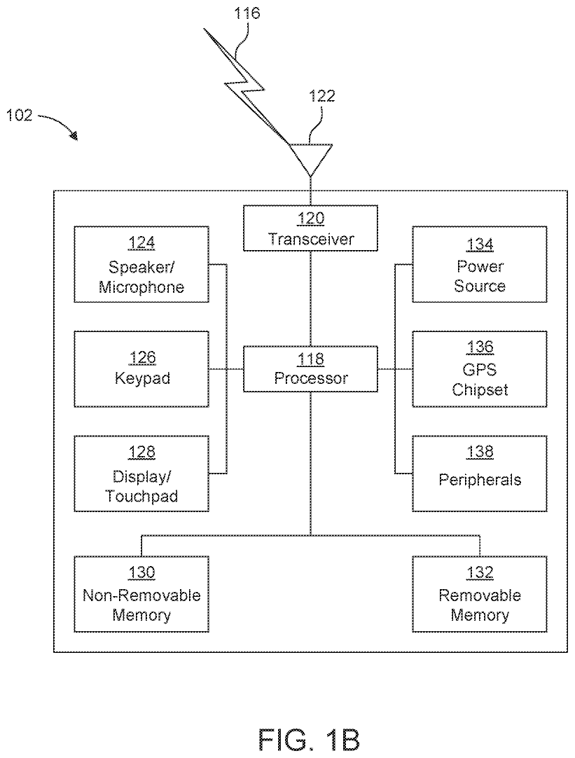

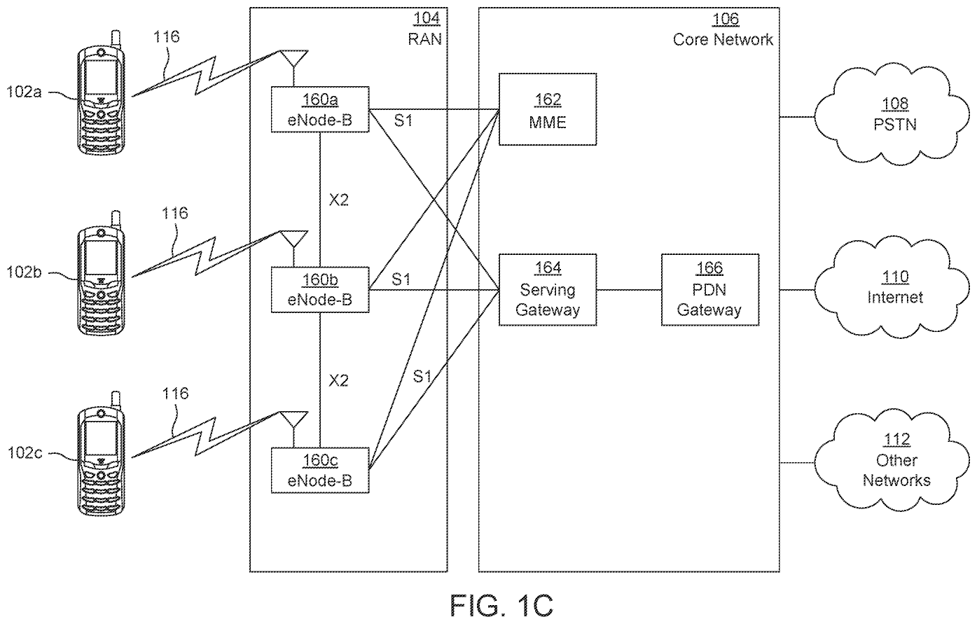

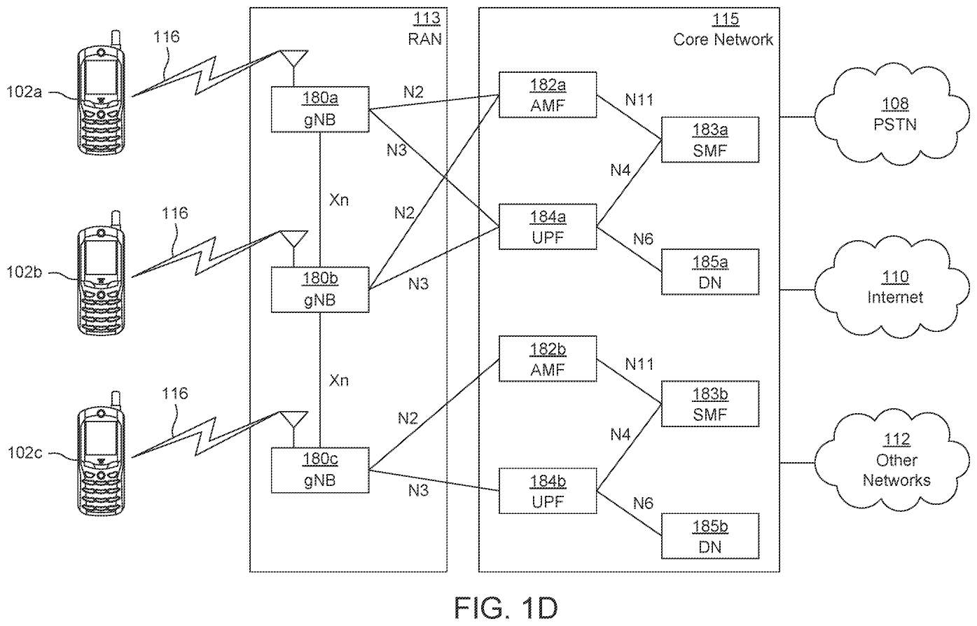

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an Si interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In anon-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### INTRODUCTION

### Example of Symbol Modulation in a Physical (PHY) Layer

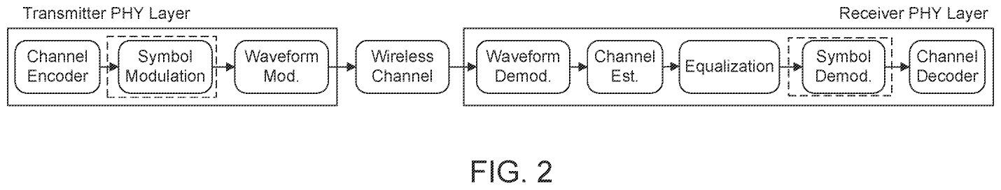

Mobile communications are in continuous evolution and are already at doorsteps of its fifth incarnation, which is called 5^{th} generation, and may be referred to herein as 5G. Referring to FIG. 2, a wireless communication system may include (e.g., devices including) a transmitter PHY layer and a receiver PHY layer. The transmitter PHY layer may be included as a part of a WTRU or a base station. The receiver PHY layer may be included as a part of another WTRU or a user equipment. The transmitter PHY layer may include any of a channel encoder block, a symbol modulation block, and a waveform modulation block. The receiver PHY layer may include any of a waveform demodulation block, a channel estimation block, an equalization block, a symbol demodulation block and a channel decoder block.

The symbol modulation block may convert a group of encoded bits to complex symbols that represent the in-phase and quadrature components of a baseband signal. The symbol demodulation block may convert the received baseband (e.g., complex) signals to group of bits that are fed into the channel decoder block. The number of bits carried within a symbol may depend on a modulation order (Qm) of a modulation scheme.

Table 1 lists examples of modulation schemes and associated modulation orders that may be used (e.g., used in 5G physical downlink shared channel (PDSCH)) in a wireless communication system.

TABLE 1
Example of modulation scheme and modulation order

| Modulation scheme | Modulation order Qₘ |
|---|---|
| QPSK | 2 |
| 16QAM | 4 |
| 64QAM | 6 |
| 256QAM | 8 |

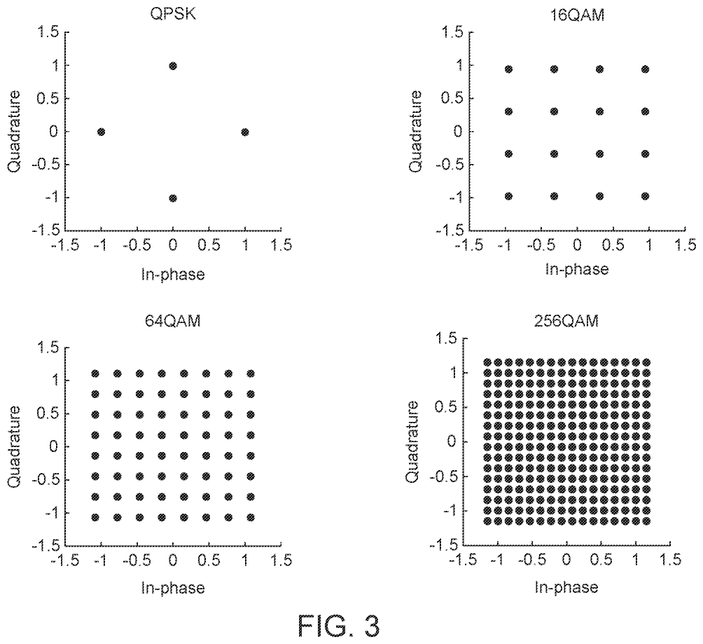

FIG. 3 shows a non-limiting example of a constellation diagram of Quaternary Phase Shift Keying (QPSK), 16 quadrature amplitude modulation symbols (16QAM), 64 quadrature amplitude modulation symbols (64QAM) and 256 quadrature amplitude modulation symbols (256QAM) modulation scheme.

The modulation schemes may be used in combination with a channel coding to determine a spectral efficiency of data transmission. The combination of a modulation scheme and a coding scheme (collectively “MCS”) may be referred to by a MCS index (Imcs).

Table 2 lists, for each of a plurality of MCS indexes, Imcs, a Qm, a target code rate and a spectral efficiency for a PDSCH (e.g., in 5G).

TABLE 2
Example of MCS index for PDSCH

| MCS Index | Modulation Order | Target code | Spectral |
|---|---|---|---|
| I_{MCS} | Qₘ | Rate R × [1024] | efficiency |
| 0 | 2 | 120 | 0.2344 |
| 1 | 2 | 157 | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 438 | 2.5664 |
| 18 | 6 | 466 | 2.7305 |
| 19 | 6 | 517 | 3.0293 |
| 20 | 6 | 567 | 3.3223 |
| 21 | 6 | 616 | 3.6094 |
| 22 | 6 | 666 | 3.9023 |
| 23 | 6 | 719 | 4.2129 |
| 24 | 6 | 772 | 4.5234 |
| 25 | 6 | 822 | 4.8164 |
| 26 | 6 | 873 | 5.1152 |
| 27 | 6 | 910 | 5.3320 |
| 28 | 6 | 948 | 5.5547 |

| | | |
|---|---|---|
| 29 | 2 | reserved |
| 30 | 4 | reserved |
| 31 | 6 | reserved |

In the example of Table 2, there are three indices for MCS index. The Qm, the target code rate and the spectral efficiency may be used to determine the MCS for transmission between a base station and WTRU. Prior to the start of a downlink/uplink transmission, the base station may instruct the WTRU to select an MCS index table.

Selection of MCS in the downlink, (e.g., link level adaptation), may be based on a channel quality indicator (CQI) value that may be sent from the WTRU to the base station. Selection of the MCS in the uplink may be based on a sounding reference signal (SRS) sent from the WTRU to the base station. After the base station receives the CQI/SRS from the WTRU, the base station may select the MCS with highest spectral efficiency for downlink/uplink that satisfies a pre-defined maximum transport block error rate. As the base station receives new CQI/SRS from the WTRU, the MCS may be continuously updated for the physical downlink shared channel and/or physical uplink shared channel (PDSCH/PUSCH).

### Example Autoencoder Neural Network (NN)

An autoencoder may be a (e.g., special) type of NN that use an unsupervised learning algorithm. A NN network that learn unsupervised may not determine what the result of the learning process may look like. An autoencoder may try to find a low-dimensional representation of an input at an intermediate layer thereof that is reconstructed at an output with minimum error. A non-limiting example structure of an autoencoder (“autoencoder structure”) is shown in FIG. 3. As shown in FIG. 3, the autoencoder structure may have 5 layers (L=5), 5 inputs and 5 outputs. An autoencoder may have multiple dense layers. In an autoencoder, the (e.g., training) parameters may be trained so that an output is as equal as possible to the input for a given example training data set. The training may be based on minimizing a cost function dependent on the difference between desired output and actual output with respect to the neural network parameters. A cost function may measure a performance of a machine learning model for given data. The cost function may quantify an error value between predicted values and expected values and may present it in the form of a single real number.

A non-limiting example of a cost function can be defined as:

$$C ( Θ ) = \frac{1}{2 N} {\sum }_{i} {( {y}_{i} - {a}_{i}^{( L )} )}^{2} \qquad ( 1 )$$

wherein:
   Θ denotes the set of trainable parameters;
   yᵢ denotes the i-th example output in the training data;
   aᵢ^{(L)} denotes the i-th actual output of the neural network; and
   N denotes the number of examples in the training data set.
      A feedforward and a backpropagation operation may be based on finding a local optimum of the cost function parameters Θ={Θ⁽¹⁾, . . . , Θ^{(L-1)}}.

A non-limiting example of computations corresponding to one or more of the feedforward operations may be as follow:

$$1 : Compute activations for l = 1$$

$${a}^{( 2 )} = σ ( {x ( {Θ}^{( 1 )} )}^{T} )$$

$$2 : Compute activations for 1 < l < L$$

$${a}^{( l + 1 )} = σ ( {{a}^{( l )} ( {Θ}^{( l )} )}^{T} )$$

An example activation function σ(⋅) is sigmoid where

$$σ ( w ) = \frac{1}{1 + {e}^{- w}} .$$

A non-limiting example of computations corresponding to the backpropagation operations may be as follows:
1: Compute one or more error value for output layer l=L

$${δ}^{( L )} = \frac{1}{N} ( y - {a}^{( L )} ) \cdot {σ}^{′} ( {a}^{( L )} )$$

where σ′(a^{(L)}) is the derivative of function σ(w) evaluated at w=a^{(L)} and y=x for an autoencoder.
2: Compute partial derivatives of the cost function C(Θ) wrt. parameters Θ^{(L-1)}.

$$\frac{\partial C ( Θ )}{\partial {Θ}^{( L - 1 )}} = {( {δ}^{( L )} )}^{T} {a}^{( L - 1 )}$$

3: Back one layer, l=l−1
4: Compute one or more error value for hidden layer l.

$${δ}^{( l )} = {δ}^{( l + 1 )} {Θ}^{( l )} \cdot {σ}^{′} ( {a}^{( l )} )$$

5: Compute the partial derivatives of the cost function. parameters Θ^{(l)}.

$$\frac{\partial C ( Θ )}{\partial {θ}^{( l )}} = {( {δ}^{( l + 1 )} )}^{T} {a}^{( l )}$$

6: Repeat 3 to 5 until l=1 where a⁽¹⁾=x.

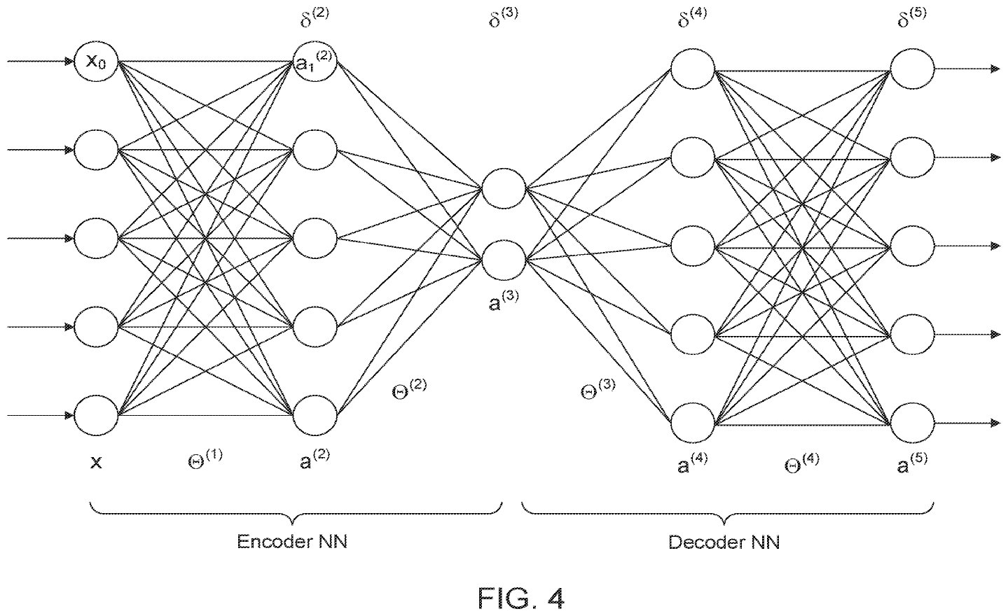

The variables in the feedforward and backpropagation operations may be all matrices. For example, in FIG. 4, a⁽³⁾ is a matrix of size N×2, Θ⁽²⁾ is of size 2×5, δ⁽³⁾ is of size N×2.

As non-limiting example, the parameters may be updated following a completion of one or more feedforward and backpropagation iterative process as follows:

$${Θ}_{t + 1}^{( l )} = {Θ}_{t}^{( l )} - η \frac{\partial C ( Θ )}{\partial {Θ}_{t}^{( l )}} for l = 1 , … , L - 1$$

wherein:
   t denotes the iteration number; and
   η>0 denotes the learning rate.

The initial parameters Θₜ⁽¹⁾ for t=0 may be determined randomly. At each iteration t, feedforward and backpropagation operations may be computed until the cost function returns a value below a threshold or maximum number of iterations are achieved.

Example Modulation Learning with an Autoencoder.

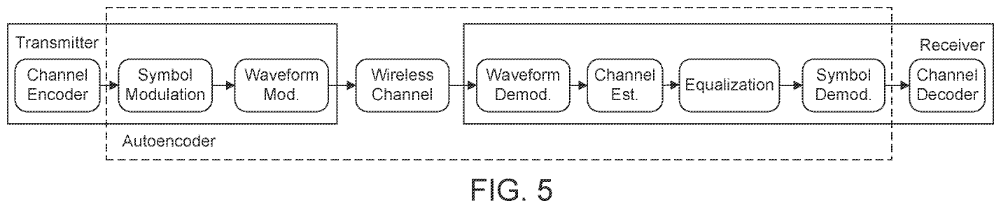

Autoencoder-based communication systems may be used in wireless communications. Autoencoder may be use in place of symbol mapper and demodulator (e.g., as shown in FIG. 5); noting that other elements in between the PHY layers may be assumed to be non-trainable.

An autoencoder in PHY layer may determine some representations of input messages in an intermediate layer.

Effects of distortions created by wireless channel, transmitter/receiver hardware impairments, and any other effect that may impact an (e.g., efficient) transmission of a signal from the base station to the WTRU may be limited by the representations of input messages. For example, in FIG. 4, a robust representation of input messages corresponds to a⁽³⁾ for the inputs x.

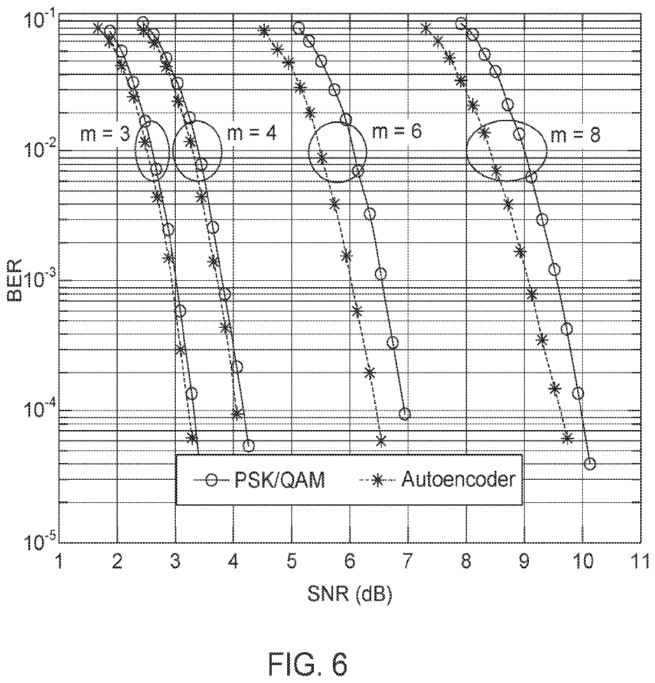

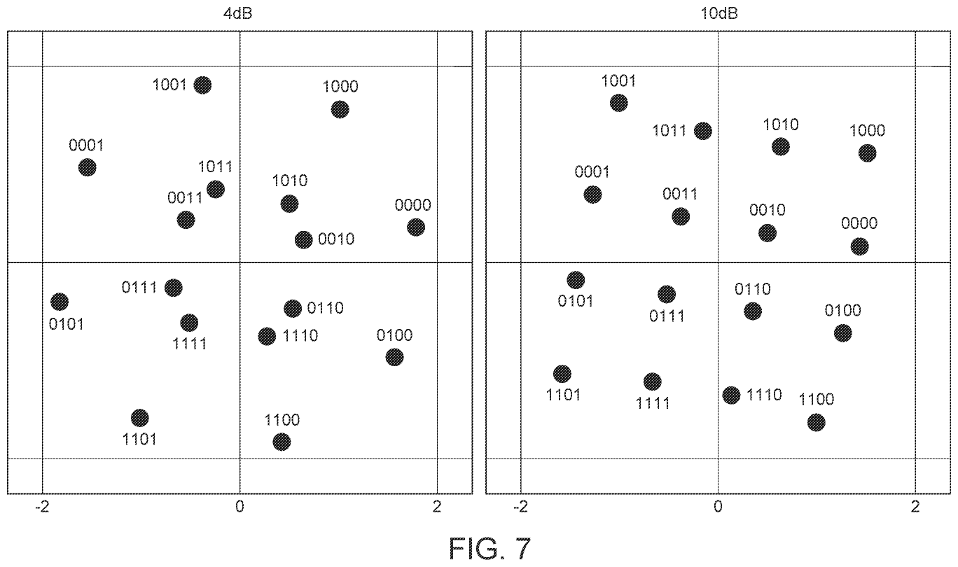

Replacing symbol modulation block and symbol demodulation block with autoencoders may improve the bit error rate (BER) performance of the PHY layer. Examples of BER vs. signal to noise ratio (SNR) curves for trained autoencoder are depicted in FIG. 6. Constellations learned using the autoencoders NN in the PHY layer may be dependent on the wireless channel properties. Examples of learned constellations for different channel properties are given in FIG. 7.

### Machine Learning Methods for Wireless Communication

Machine learning methods at the PHY layer of wireless communications may have the potential to adapt rapid-time varying channel conditions and non-linear impairments for robust and efficient transmissions. However, a practical deployment of data-driven, (e.g., machine learning based adaptive communications in the physical layer), may require efficient signalling and feedback methods and procedures as part of the overall physical layer and supporting elements in the communication stack. For wireless transmission at high frequency bands such as mmWave and THz, non-linear impairments may become the dominant source of received signal distortions. However, conventional PHY layer approaches lack methods and procedures to handle non-linear impairments.

Machine learning methods, (e.g., neural networks), may replace PHY layer blocks either as a whole or partially. A block of the PHY layer may be a look-up table based on fixed symbol modulation. Fixed modulation types may not adapt to the specifics of channel conditions or RF impairments. An aka constellation diagram, e.g., BPSK, QAM, etc may be pre-determined in accordance with the noise statistics (which is often assumed to be independent and identically distributed Gaussian). Depending on the SNR value of a received signal, a (e.g., particular) modulation point may be selected from the pre-determined constellation diagram.

Learning methods for the PHY layer may use additional signalling and feedback compared to conventional control channels of state-of-the-art communication standards (e.g., 5G). Signalling procedures, such as reference signals, defined in current standards may fall short of satisfying the requirements of training processes of PHY layer blocks. Existing uplink feedback or downlink piloting procedures may not support modulation learning. Offline learning methods may reflect the statistics of the channel conditions, however when the underlying channel statistics change, (e.g., a user moves to an urban location), then the offline neural network (NN) models may not be sufficient.

A machine learning (ML)-based modulator (e.g., constellation shaper/modulator NN) may (e.g., adaptively) provide a symbol constellation. A machine learning (ML)-based modulator may map a bit-stream into transmit symbols at the base station based on the constellation.

At the WTRU, a ML-based demodulator (e.g., demodulator NN) may de-map the received symbols into bit sequence for final decoding, based on the corresponding symbol constellation.

### Methods and Procedures for Training of Data-Driven Constellation Shaper for WTRU Specific Symbol Modulation.

According to one embodiment, methods and procedures may enable trainable data-driven constellation shaper for adaptive symbol constellation diagrams and modulation mapping. Systems and methods for a training of a data-driven constellation shaper that enables adaptive symbol constellation diagrams and modulation mapping at the base station and at the WTRU may include any of the following steps:
Based on the location and/or channel statistics of the WTRU, the base station may select an index from a codebook that contains a set of parameters of the constellation shaper to be used for training initialization and sends the parameter index to the WTRU.
The base station may start a training procedure and may send one or more training reference signals (TR-RS) to the WTRU for each training step/iteration,
WTRU may:
   update the parameters of the constellation shaper at the WTRU using the received TR-RS at each step/iteration;
   prepare a training quality indicator (TQI) that consists of the state of the training convergence and loss;
   compute training error values;
   feedback the error values to the base station after each training step/iteration;
   report TQI periodically to the base station;
   if the training converges within an observation period:
      the WTRU may notify the base station with the completion of training;
      the trained constellation may be deployed at the base station and at the WTRU.
   if loss values within as observation period are above a preconfigured/predefined TQI threshold, then the WTRU may notify the base station with the failure of the training.
The base station may:
   update the parameters of the constellation shaper at the base station using the error signals at each step/iteration;
   based on the received TQI, decide to continue the training, stop the training to deploy current parameters at the base station and at the WTRU, or terminate the training;
   if the base station decides to terminate the training, conventional modulation is deployed at the base station and at the WTRU.

As an example, the trainable data-driven constellation shaper may be a neural network (NN) structure at the base station and at the WTRU. The NN structure may be used to replace or complement fixed symbol modulation.

Example Symbol Modulation/Demodulation with Autoencoders

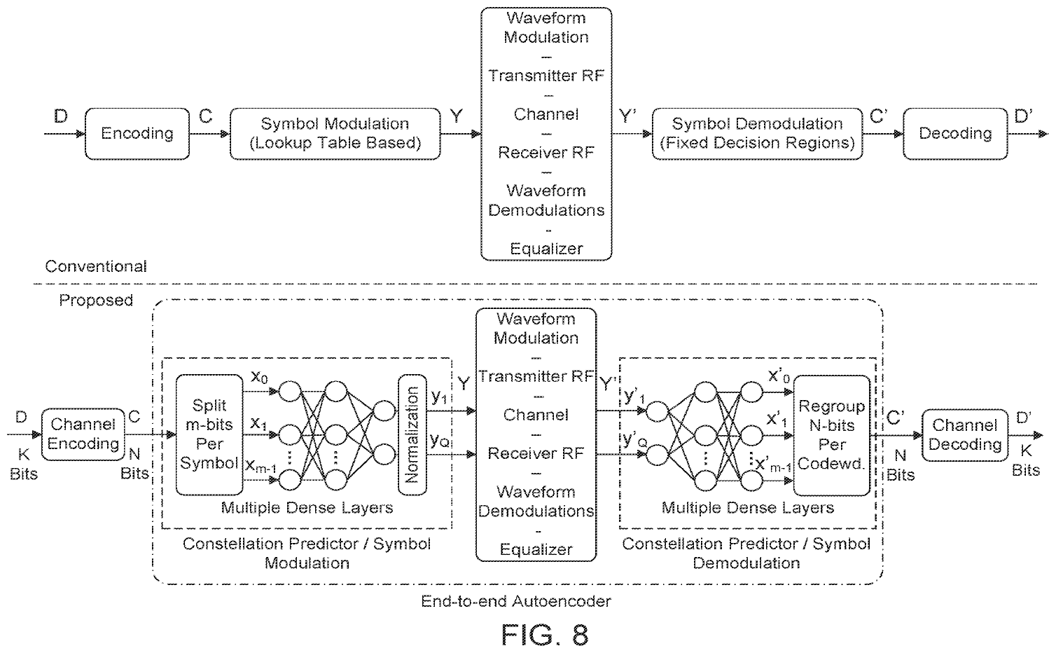

FIG. 8 is anon-limiting example of a block diagram of an end-to-end autoencoder of PHY layer of wireless communications and a conventional PHY layer of wireless communications. For simplicity, the intermediate blocks and processes are represented in a single box that may include waveform modulation block, base station RF block, wireless channel block, WTRU RF block, waveform demodulation block, channel estimation block and equalizer block. A fixed look-up table-based symbol modulation/demodulation processes of the conventional PHY layer may be replaced with an underlying NN structure for the end-to-end autoencoder PHY layer. As an example, a low-density parity check (LDPC) encoder/decoder may be used for channel coding.

According to the end-to-end autoencoder PHY layer, the input to channel encoder D may consist of K message bits. The output C may consist of N encoded bits. As part of the symbol modulator NN, encoded bits may be split into m-bits per symbol (modulation order), x₀, x₁, . . . , xₘ₋₁, that are input to the neural network (NN). The inputs to the NN may be represented with +1 for binary ‘1’ or −1 for binary ‘0’, so that xᵢ∈{+1, −1}. M-ary symbol modulation may provide M=2^{m} (e.g., possible) inputs to the NN. The NN output may map m inputs to two real valued outputs, y_{I} and y_{Q}. A power normalization, to ensure the same average bit energy (for bits in D) for every M-ary modulation, may be applied to the two real valued outputs. The outputs y_{I} and y_{Q} may represent the in-phase and quadrature components of a complex symbol that is fed into the waveform modulator NN, such as OFDM.

The symbol demodulation at the WTRU may be provided with output samples of the equalizer block, y′_{I} and y′_{Q}, which may be real valued samples that represent the in-phase and quadrature components of the received complex symbols. The real valued samples, y′_{I} and y′_{Q}, may be input to the demodulator NN at the WTRU. The demodulator NN may have m outputs, x′₀, x′₁, . . . , X′ₘ₋₁, that may represent the received encoded binary symbols where x′ᵢ∈{−1, +1}. The received encoded symbols may be regrouped to form N-bit long codeword symbols C′ which may be fed into the channel decoder (e.g., LDPC decoder). The output of channel decoder D′ may represent decoded message bits at the WTRU.

### Scalable NN Structure for M-Ary Modulation

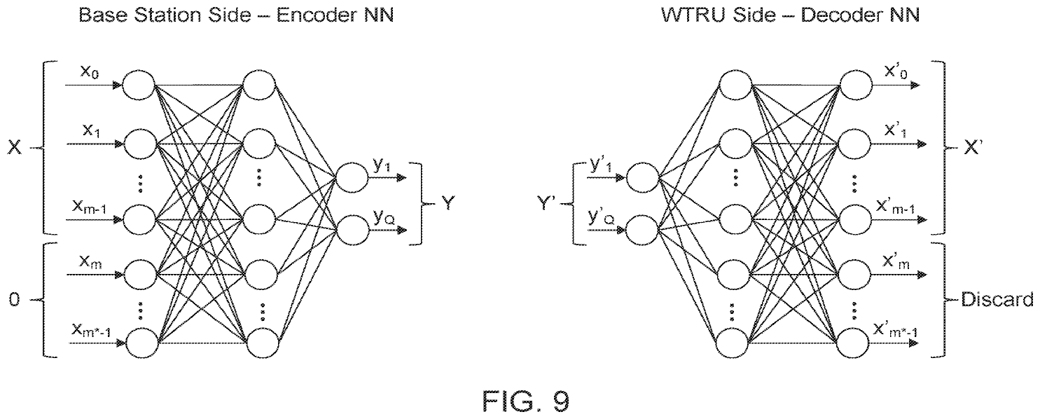

FIG. 9 is anon-limiting example of a scalable NN structure that can be trained for M-ary modulations. M represents the size of the constellation. The size of the constellation, M, may be changed arbitrarily. The scalable NN structure may be constructed for a maximum number of input size m* while some of the NN inputs at the base station side may be padded with zeros, so that xᵢ=0 for i≥m. The NN outputs x′ᵢ at WTRU side for i≥m may be discarded during the demodulation stage. The scalable NN structure may allow maximum M-ary modulation where M=2^{m*}. The maximum number of input size m* may depend on the implementation complexity, training overhead, etc.

The scalable NN structure for modulation learning allows training for (e.g., all) possible M-ary modulations within a (e.g., given single) NN structure. Another option for NN structure for modulation learning may be to construct separate NNs for each m, which may be expected to incur additional complexity and memory requirements.

### Training Reference Signals (TR-RS) for PHY Layer

The training reference signals (TR-RS) may be used as part of the feedforward computations to train a NN. A TR-RS may consist of a (e.g., single) complex symbol, Y=y_{I}+y_{Q}j, that may represent the output of the base station autoencoder (e.g., the symbol modulator NN). The complex symbol, Y=y_{I}+y_{Q}j, for a given input X={x₀, . . . , xₘ₋₁}. y_{I} and y_{Q} may

be continuous real value such that {y_{I}, y_{Q}∈ [symbol] : −1<y_{I}<1, −1<y_{Q}<1}. y_{I} and y_{Q} may be quantized with a default precision prior to waveform modulation.

The complex signals transmitted within a TR-RS may be specific to WTRUs that is determined based on the weights of the base station autoencoder. A TR-RS may be located on any resource element that are reserved to the WTRU following initial access procedures. Prior to data transmission from base station to WTRU, (e.g., all) reserved resource elements may be used for TR-RS transmissions to complete the training. A part of the reserved resource elements may be used for TS-RS transmissions. Data transmission may be carried over regular fixed type modulations, until the symbol modulation training process finishes.

The sequence of X used to generate TR-RS may be known to the base station and WTRU in advance. A sequence of X for modulation training may include any possible inputs of an M-ary modulation. For example, for m=4, X⁰=0000, X¹=0001, . . . , X^{M-1}=1111, where Xⁱ denotes the i-th input sequence. The complex symbol carried by the i-th TR-RS, Yⁱ=y_{I}ⁱ+y_{Q}ⁱj, may be computed based on the weights of the transmitter autoencoder.

Example Feedback from the WTRU to the Base Station.

To train the base station and the WTRU autoencoder NNs, feedback may be sent from WTRU to the base station as part of the backpropagation computations. The feedback from the WTRU to the base station may include trained WTRU autoencoder weights and/or error values for backpropagation algorithm.

As anon-limiting example, a physical uplink control channel (PUCCH) of 5G uplink may be used to transmit the feedback from the WTRU to the base station. As another non-limiting example, a PUCCH Format-X may be used to transmit the feedback from the WTRU to the base station. The Format-X may extend to any dedicated uplink resource elements of the WTRU, e.g., the entire dedicated resource elements maybe used for the Format-X. As another non-limiting example, the feedback from the WTRU to the base station may be sent over a physical uplink shared channel (PUSCH) on dedicated uplink resources of the WTRU.

Another feedback sent by the WTRU to the base station may be the TQI including the quality of the learned symbol constellation diagrams. The TQI value may include the WTRU NN loss (TQI loss) which may be computed when a known TR-RS sequence is received at the WTRU. The TQI value may also include convergence of the loss (TQI loss&convergence). The TQI loss may be computed during a quality test procedure. The TQI loss&convergence may be computed during training. WTRU may send TQI loss to the base station whenever it receives a test TR-RS sequence from the base station. In addition, the WTRU may send periodic TQI loss&convergence to the base station during the training procedure for the purpose of tracking of the training status. TQI may be sent within a Training Status Message over PUCCH as well as with in a channel state information (CSI) report.

### Autoencoder Training Process and Required Signalling

Training process of the autoencoder may be performed offline or online. Offline training may be performed within a computer simulator for a given channel statistics. However, offline training may not reflect the channel conditions specific to a WTRU. Offline trained NN weights may be used as initialization for online training. A codebook for NN parameters may include a lookup table comprising weights and structure (number of layers, nodes) of offline trained NN for different channels. The codebook may be shared between the base station and the WTRU. After the WTRU completes the initial access procedures, the base station may select parameters to be used for the corresponding base station to WTRU connection. The base station may further send the index of parameters from the shared codebook to the WTRU. Table 3 is a non-limiting example of a shared codebook structure.

TABLE 3
Example of Codebook of NN parameters for m *= 8

| NN Index | Structure | | |
|---|---|---|---|
| I_{NN} | (nodes per layer) | Weights | Type of Channel |
| 0 | [2, 8, 8] | [0.0235, −0.4511, 0.7890, . . .]_{1×80} | Stationary, high SNR |
| 1 | [2, 8, 8, 8] | [0.3501, 0.0511, −0.2084, . . . ]_{1×144} | Low mobility, medium SNR |
| 2 | [2, 16, 8] | [−0.7394, −0.0034, 0.6318, . . .]_{1×160} | Medium mobility, medium |
| | | | SNR |
| . . . | . . . | . . . | . . . |

The non-limiting example of the codebook lookup table of Table 3 may include NN index, structure, weights, and the corresponding type of channel the NN is trained for. NN index may denote the index of the chosen NN parameters. Structure field may be composed of an array of size of the number of layers and each element of the array indicates the nodes per layer. As an example, [2,16,8] structure may denote a NN with three layers and each layer has 2, 16, and 8 nodes, respectively. Weights field may be composed of an array of size of the number of NN weights. As an example, [2,16,8] structure may denote a NN weight array of size 2×16+16×8=160.

In Table 3, structure, weights and type of channels are exemplary and the table may be extended for any type of channel. A NN index denotes the index of the chosen NN parameters. Structure field may be composed of an array of size of the number of layers and each element of the array indicates the nodes per layer. As an example, [2,16,8] structure denotes a NN with three layers and each layer has 2, 16, and 8 nodes, respectively. Weights field may be composed of an array of size of the number of NN weights. As an example, [2,16,8] structure denotes a NN weight array of size 2×16+16×8=160.

Online training may be performed specific to the channel impairments between a base station and a WTRU. For the training process, training data set may be used for feedforward and back propagation computations. In case of autoencoder for modulation learning, known X sequences may be transmitted from the base station to the WTRU. The WTRU may compute the training loss based on a metric measuring the similarity between X′ and X. The known training X sequences may be transmitted with a reference signal, TR-RS. In training the autoencoders, for a given m, there are M=2^{m} (e.g., unique) inputs X. For example, if m=6, there are M=64 (e.g., unique) binary inputs. For a scalable NN structure as given in FIG. 9, the total number of (e.g., unique) inputs Nu may be computed as N_{U}=2^{m*+1}−1. For example, for m*=8, there are N_{U}=511 distinct training reference signals. In order to train the autoencoder, (e.g., all unique) inputs may be used in the training data set at least once. Repeating (e.g., all) the (e.g., unique) inputs more than once for training data set may yield better convergence of the NN training process.

In one training process embodiment, training step/iterations may be computed jointly at the base station and a the WTRU. Let Xⁱ={x₀ⁱ, . . . , xₘ₋₁ⁱ} denote the i-th input used to generate i-th TR-RS signal represented by Y_{TR}ⁱ for 1≤i≤N_{TR}, where N_{TR} denotes the number of TR-RS signals required to complete the training. The number of training symbols to complete the training may be dynamically determined based on the convergence of the NN weights, so that N_{TR}=c·Nᵤ, where c is an integer greater than or equal to 1. This implies that (e.g., all unique) input symbols may be passed to the WTRU at least once as part of the feedforward computations of the iterative learning process. To be consistent with the NN training notations, c may represent the number of periods of the training process. A period of a training process is denoted herein as an epoch. One epoch is one feedforward operation and one backpropagation operation of a training process. At (e.g., each) an epoch of training process during base station to WTRU transmission, at least Nᵤ (e.g., unique) TR-RS pilots may be sent from the base station to the WTRU as part of the feedforward computations. In addition, the training process may use test data set during the step/iterations. Hence, (e.g., all unique) TR-RS pilots may be sent twice, so that one set may be used for training and other set may be used for test for an (e.g., each) epoch.

Once (e.g., all) TR-RS pilots for an epoch are received at the WTRU, backpropagation computations may be performed as the other part of the training process. The WTRU may feedback the error values, δ, for the two input neurons Y′, for (e.g., each) the training symbols. Error values (e.g., each error value) may be represented with floating point type as 32 bits. This creates a feedback of size 2·N_{U}·32 bits. For example, for m*=8, the operation corresponds to 32704 bits of feedback to be sent from the WTRU to the base station for an (e.g., each) epoch. The feedback may either be sent from the PUCCH control channel with existing feedback formats or PUCCH control channel with the Format-X or over the PUSCH data channel.

The learning phase epochs may continue with TR-RS transmission from the base station to the WTRU until maximum number of epochs is reached or until the NN parameters converge through a local optimum at the NN loss function. The learning phase periods may further continue feedback from the WTRU to the base station, until maximum number of learning phase periods is reached or until the NN parameters converge through a local optimum at the NN loss function. At the end of training, the WTRU may send the trained NN parameters to the base station. the base station may store the trained NN parameters to update the codebook and use the WTRU weights for updating link level adaptation mechanism. The size of the feedback may depend on the number of trainable weights N_{W} at the WTRU. The (e.g., each) weights N_{W} may be represented with floating type as 32 bits. This creates a PUCCH feedback of size N_{W}·32 bits. For example, for a 4-layer deep NN of size 2×8×8×8 at WTRU, N_{W}=16+64+64=144.

In another training process embodiment, training step/iterations may be computed (e.g., only) at the base station. In this case, the base station may send a larger number of TR-RS pilots once to the WTRU, so that all N_{TR}=2·c·Nᵤ TR-RS pilots may be sent including the test pilots. For example, if c=50 and m*=8, then N_{TR}=51100 TR-RS pilots are sent together at once. At the WTRU, the inputs to the symbol demodulator NN, Y′, (e.g., the output samples of the equalizer block), may be sent to the base station as a feedback. The two real valued outputs of the equalizer block may be represented with floating point type as 32 bits. This may create a feedback of size 2·N_{TR}·32. For example, if c=50 and m*=8, then 3 270 400 bits of feedback may be sent from the WTRU to the base station once. The feedback may be sent over the PUCCH control channel or PUCCH control channel with Format-X or PUSCH data channel.

The learning phase in this training process embodiment may be carried out by the base station. The base station may initialize the autoencoder structure and at an (e.g., each) epoch in the base station, one set of N_{U} TR-RS pilots may be used. The learning phase may continue until maximum number of epochs is reached or the NN parameters converge through a local optimum at the NN loss function. At the end of the training, the base station may send the trained weights to the WTRU. This creates a physical downlink control channel (PDCCH) transmission of size N_{W}·32 bits. For example, for a 4-layer deep NN of size 2×8×8×8 at WTRU, N_{W}=16+64+64=144.

### Example Updating Link Level Adaptation Mechanism at the Base Station.

At the end of the training process of symbol modulation learning, the base station may provide a WTRU (e.g., specific) link level adaptation mechanism to determine the type of modulation and coding scheme (MCS), and the coding rate for a given WTRUSNR. BER versus SNR curves may be used to select the MCS with highest spectral efficiency that may achieve a target block error rate (BLER).

In one scenario, the base station may determine an approximation of the BER vs. SNR using the minimum distance in the trained constellation diagram assuming Gaussian noise.

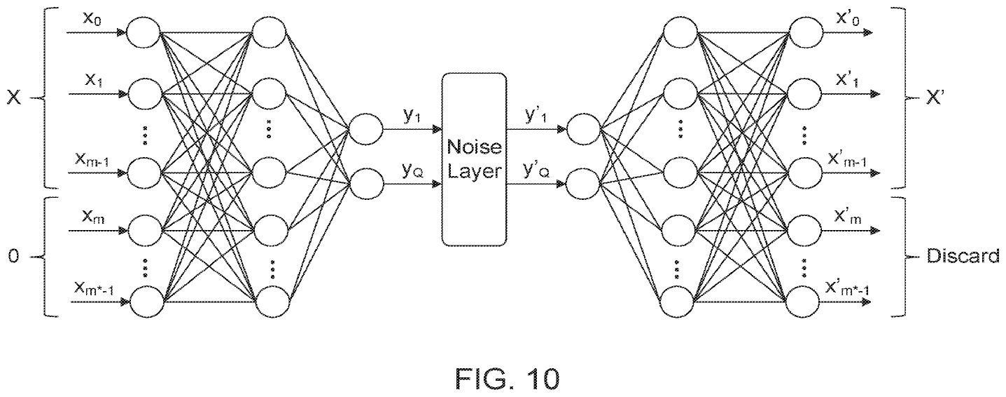

In another scenario, as shown on FIG. 10, the base station may determine a twin model of the autoencoder structure. The twin model may be used within a simulation to obtain the BER vs. SNR curves for all M-ary modulations for any given code rate. The simulation may be used to construct BER vs. SNR curves for all m for a given code rate.

WTRU Specific Symbol Modulation Learning Procedure with Online Training

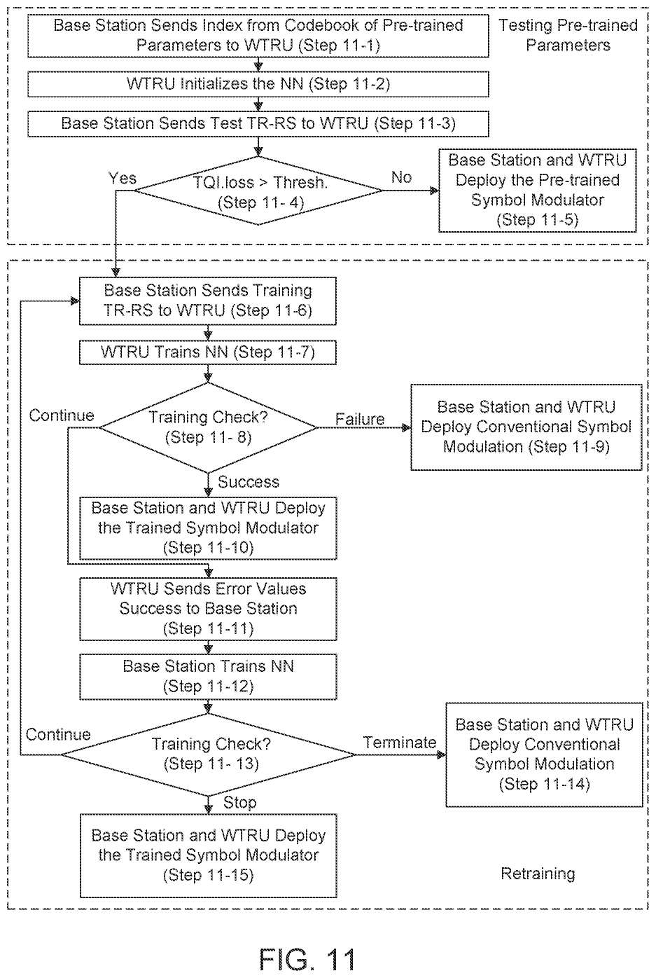

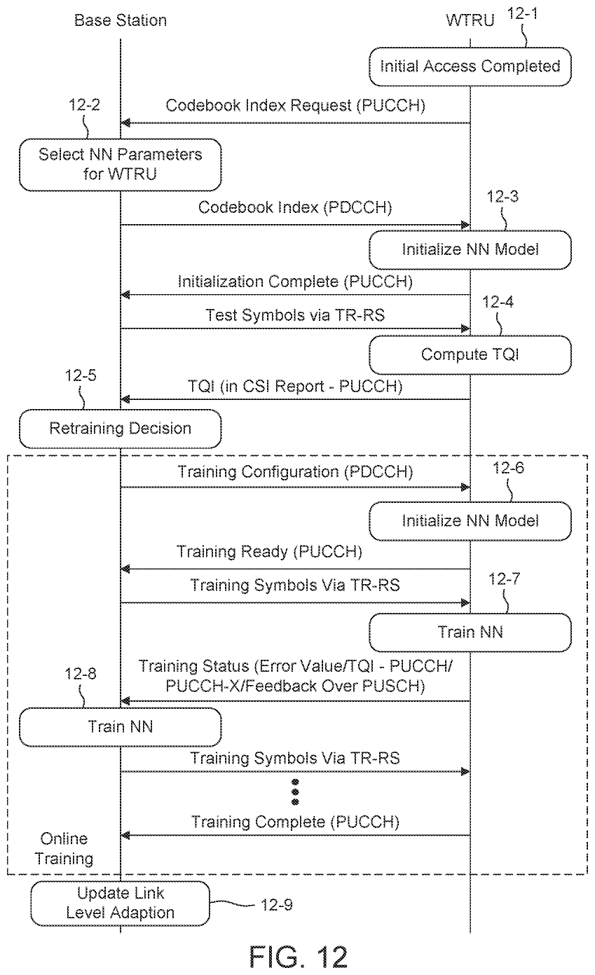

Anon-limiting example of a method for symbol modulation learning with online training may be depict according to the flowchart diagram of FIG. 11 and according to the procedure diagram of FIG. 12. The symbol modulation learning may include joint online training at both base station and WTRU.

Referring to the flowchart diagram of FIG. 11, the method for symbol modulation learning may include the following steps:

At step 11-1, a base station may select an index from a codebook of NN parameters, e.g., Table 3. The NN parameters are referred herein as pre-trained parameters. The base station may send the index to a WTRU. The selection of the index is based on information received form the WTRU. Prior to step 11-1, the method may include a step wherein the WTRU may complete an initial access procedure and may send the (e.g., specific) information such as location, statistics of the underlying wireless channel and device impairment statistics (e.g., carrier frequency offset, analog to digital converter (ADC) loss, timing offset, noise figure, etc.) to a base station.

At step 11-2, the WTRU may initialize the NN model using the received index of the codebook. The WTRU may send to the base station an initialization complete message.

At step 11-3, the base station may send a TR-RS test sequence to the WTRU to test the initialized NN.

At step 11-4, a TQI may be computed and may be compared with a TQI threshold. According to one embodiment, the WTRU may demodulate the output samples of the equalizer for received TR-RS test symbols of the test sequence to compute the WTRU NN output loss. The WTRU may send to the base station, the NN loss as part of the TQI which may include loss to the base station within the CSI reporting feedback.

If the loss value of the TQI is below a TQI threshold, then the base station may decide there is no need for retraining, such that, at step 11-5, the base station and the WTRU may deploy the pre-trained parameters for setting up respectively symbol modulator NN and symbol demodulator NN.

If the loss value of the TQI is above a TQI threshold, then the base station may decide to retrain the symbol modulator/demodulator NN. Prior to retrain the symbol modulator/demodulator NN, the base station may send a training configuration message to the WTRU to configure the training process with loss convergence and maximum iteration constraints. The WTRU may reply to the base station with a training ready message via a PUCCH.

At step 11-6, to retrain the symbol modulator/demodulator NN, the base station may send training symbols via TR-RS to the WTRU.

At step 11-7, the WTRU may train the WTRU NN using the received TR-RS training symbols and updates the NN parameters by computing the WTRU NN output loss and error values for the nodes in the NN.

At step 11-8, a first training check test may be processed at the WTRU side. The first training check test may consist of analysing loss convergence and the number of iterations.
In case, the loss does not converge within a maximum number of iterations, a training failure is determined. In such a case, at step 11-9, the WTRU may send a training failure message to the base station via PUCCH to terminate the training process. Upon receiving a training failure message at the base station from the WTRU, the base station and the WTRU may deploy conventional MCS respectively for the symbol modulation and for the symbol demodulation.
In case the loss converges within the maximum number of iterations, a training success (or training complete or training terminate) is determined. In such a case, at step 11-10, upon receiving a training success message at the base station from the WTRU, the base station and the WTRU may deploy the trained NN parameters for setting up respectively symbol modulator and symbol demodulator NN.
In case maximum number of iterations is not reached yet, and in case the loss does not converge, a continuation process is determined. In such a case, at step 11-11, the WTRU may feedback the error values of the input nodes of the WTRU NN to the base station via a training status message. The WTRU may also send the current loss and convergence within TQI periodically to the base station. The error values feedback may be sent over PUCCH, over a PUCCH format-X where larger size of control data may be sent, or over PUSCH data channel.

At step 11-12, the base station may train the base station NN using the error values feedback from the WTRU.

At step 11-13, a second training check test may be processed at the base station side.
At step 11-14, in case the base station determine to terminate the training process, due to any of insufficient resources, power consumption, latency, loss and convergence values in TQI etc., the base station and the WTRU may deploy conventional MCS respectively for the symbol modulation and for the symbol demodulation.
At step 11-15, in case the base station decides to stop the training, WTRU and base station may deploy the current trained parameters.
In case the base station decides to continue training process, the method may go back to step 11-6 as an iteration process.

FIG. 12 depicts an example of a signalling diagram between the base station and the WTRU for a procedure for a symbol modulation learning in accordance with the flowchart diagram of FIG. 11.

At step 12-1, the WTRU may complete an initial access procedure and may send a codebook index request message to the base station. The codebook index request message may be sent via PUCCH. The codebook index request message may include an (e.g., specific) information comprising location, statistics of the underlying wireless channel and device impairment statistics (e.g., carrier frequency offset, ADC loss, timing offset, noise figure, etc.).

At step 12-2, the base station may select NN parameters for the WTRU and determine the index from a codebook (e.g., a database) corresponding to the NN parameters. The base station may send to the WTRU a training configuration message. The training configuration message may be sent via PDCCH. The training configuration message may include the index from the codebook of NN parameters.

At step 12-3, the WTRU may initialize the NN model using the received index of the codebook. The WTRU may send to the base station an initialization complete message. The initialization complete message may be sent via PUCCH. Responding to the initialization complete message, the base station may send, to the WTRU, a training reference signal (TR-RS). The TR-RS may comprise a message including one or more test symbols.

At step 12-4, the WTRU may compute a TQI and may send to the base station, the NN loss as part of the TQI within the CSI reporting feedback. The CSI reporting feedback may be sent via PUCCH.

At step 12-5, the base station may compare the TQI with a TQI threshold such that if the loss value in the TQI is above the TQI threshold, a retraining decision is determined by the base station. In such a case the base station may send a training configuration message to the WTRU to configure the training process. The training configuration message may include any of a NN loss convergence value and a maximum iteration value constraints. The training configuration message may be sent via PDCCH.

At step 12-6, the WTRU may (re) initialize the NN model according to the training configuration message. The WTRU may reply to the base station with a training ready message via a PUCCH.

At step 12-7, following transmitting to the base station the training ready message, the WTRU may receive from the base station a TR-RS. The TR-RS may comprise a message including one or more training symbols. The WTRU may train the WTRU NN using the received TR-RS training symbols and updates the NN parameters by computing the WTRU NN output loss and error values for the nodes in the NN. In case the loss does not converge and in case maximum number of iterations is not reached, an iteration process may start. The WTRU may feedback to the base station a training status message. The training status message may include the error values, the current loss and convergence within TQI. The training status message may be sent over PUCCH, over a PUCCH format-X where larger size of control data may be sent, or over PUSCH data channel.

At step 12-8, the base station may train the base station NN based on the training status message. The base station may decide to retrain the WTRU as described at step 12-7 until a training complete message is received by the base station, from the WTRU. The training complete message may be sent over a PUCCH.

As a non-limiting example, the WTRU may decide to transmit to the base station a training complete message in case the loss converges within the maximum number of iterations. In such a case, upon receiving a training complete message at the base station from the WTRU, the base station and the WTRU may deploy the trained parameters for setting up respectively symbol modulator and symbol demodulator NN.

At step 12-9, based on the setting of the symbol modulator NN at the base station side and based on the setting of the symbol demodulator NN at the WTRU side, the base station may update the link level adaptation between the base station and the WTRU.

In an embodiment, the base station may request the final trained NN parameters for the WTRU via PDCCH through a Training Status Request Message. The WTRU may send the final NN parameters within the Training Status Message to the base station via PUCCH. The base station may store the final NN parameters to be used for updating the codebook of NN parameters and updates the link level adaptation mechanism based on the trained symbol constellation diagram.

### Systems and Methods for Data Transmission Using Data-Driven Constellation Shaper Trained for WTRU Specific Symbol Modulation

According to one embodiment, systems and methods that enable data transmission using trained symbol modulator/demodulator autoencoders are described below.

Systems and methods for data transmission using a trained data-driven constellation shaper that enables adaptive symbol constellation diagrams and modulation mapping at the base station and at WTRU (e.g., user equipment) may include the following steps:
The base station may update the link level adaptation mechanism based on the pre-trained/learned constellations and starts data transmission to the WTRU.
The WTRU may (e.g., periodically or regularly) send a CSI report including a received signal strength indication (RSSI), and CQI. The WTRU may (e.g., continuously) compute a bit error metrics for received data. If the bit error metric is above a bit error threshold, the WTRU may request a test TR-RS symbols from the base station.
The base station may configure the MCS based on the CSI report, and may (e.g., continuously) compute a hybrid automatic repeat request (HARQ) error metrics for transmitted data. If the transmission HARQ error metric is above a HARQ error threshold, the base station may send test TR-RS symbols to the WTRU.
The WTRU may compute loss upon receiving the test TR-RS symbols. The WTRU may report the loss within TQI to the base station.
The base station may decide to retrain the constellation shaper if the loss in TQI is above a preconfigured/predefined TQI threshold.

### Example Data Transmission and Adaptive MCS

Data transmission from a base station to a WTRU may follow the general rules and procedures defined in TS 38.214. The WTRU specific link level adaptation based on the symbol modulation learning method may be used. The MCS table used for link level adaptation may consist of any M-ary modulation and any coding rate. For example, typical values of M may be 4, 8, 16, . . . , 256, as M=2^{m}.

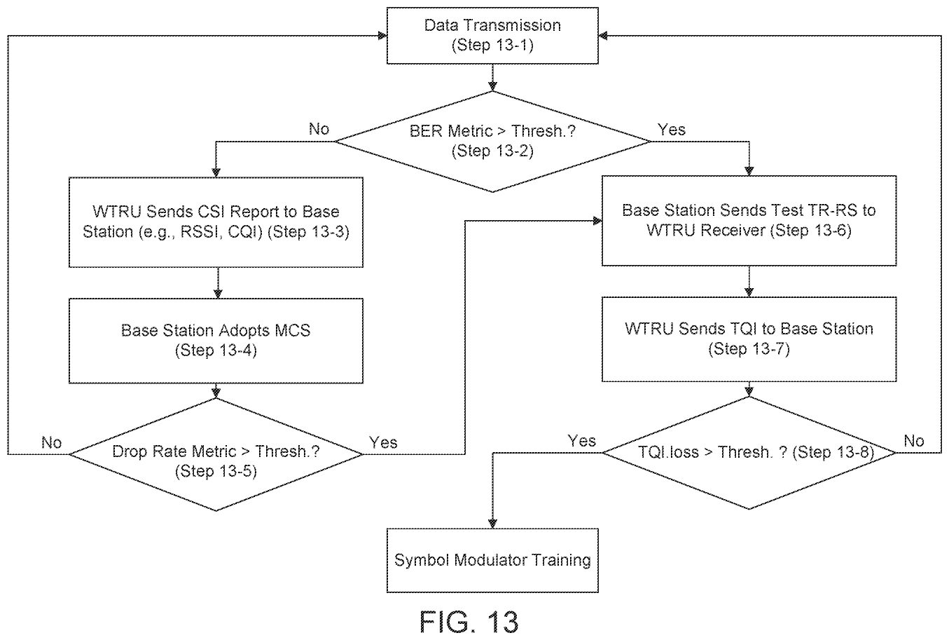

The base station may use the link level adaptation mechanism generated for the trained symbol modulator/demodulator NN. The base station may start data transmission with a selected MCS. The data transmission may be deployed according to an inference procedure as illustrated at FIG. 13. The base station may (e.g., continuously) adopt the MCS based on the CSI report (e.g., RSSI, CQI).

### Example Test TR-RS and TQI

The base station may (e.g., continuously) monitor an error metric of the drop rate of the transport Block (TBDR) for the WTRU through the HARQ process. If the HARQ error metric is above a preconfigured/predefined HARQ threshold, then the base station may send a test TR-RS to the WTRU to determine the quality of the trained symbol modulator/demodulator NN. Upon receiving the test TR-RS symbols, the WTRU may report a TQI to the base station via the CSI Report.

The WTRU may (e.g., continuously) compute a Bit_Error_Rate (BER) metric upon receiving data from the base station. If the BER metric is above a preconfigured/predefined BER threshold, then the WTRU may request one or more Test TR-RS symbols from the base station to compute and report TQI.
In one embodiment, the base station may preconfigure the WTRU to request test TR-RS from the base station, if the WTRU detects significant change in the channel statistics.
In another embodiment, the transmission of test TR-RS from the base station to the WTRU may be periodic regardless of the metric or change in channel statistics.

The test TR-RS may include more than one full set of all unique TR-RS pilots, so that N_{TR}=c·N_{U}. For c=10 and m*=8, this corresponds to 51100 TR-RS pilot signal transmissions. The test TR-RS pilot signals may be sparse in the time domain, such that they may be transmitted in burst. In an option, the transmission of test TR-RS may be periodic. For example, a test TR-RS burst may be sent from the base station to WTRU every one second.

Upon receiving the set of Test TR-RS symbols, the WTRU may compute the average loss at the output of the WTRU NN of the symbol demodulator NN. The TQI may include the average loss that may be feedback to the base station within the CSI report.

### Example Symbol Modulation Retraining

As part of the CSI reporting, TQI may be sent to the base station from the WTRU. TQI may indicate the quality of the trained symbol modulator/demodulator NN for the current state of the channel. If the loss in TQI is above a preconfigured/predefined TQI threshold, then the base station may determine retraining the symbol modulator/demodulator NN. Then the base station may start the online training procedure for the symbol modulator/demodulator NN as shown from step 11-6 to step 11-15 of FIG. 11. If the loss in TQI is below the TQI threshold, then data transmission may continue.

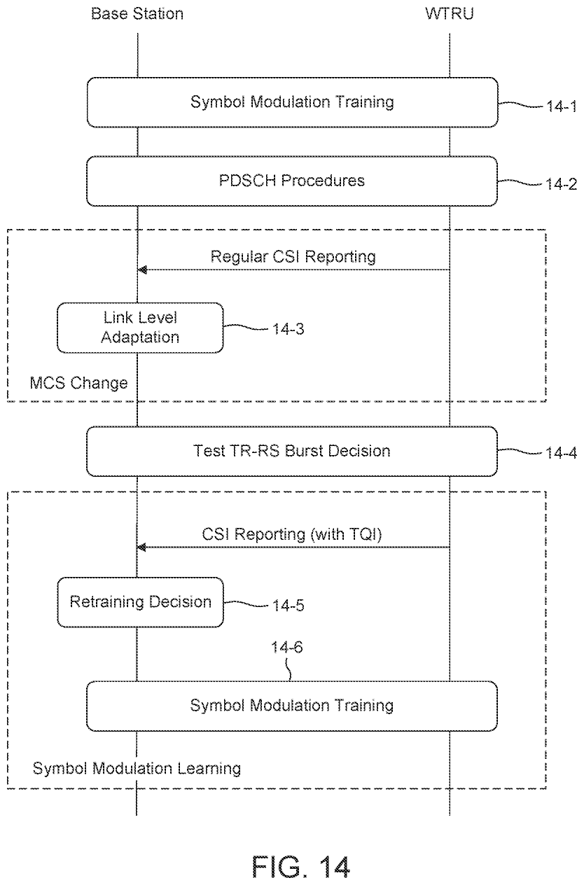

A non-limiting example of a method for data transmission using data-driven constellation shaper trained for WTRU specific symbol modulation may be depict according to the flowchart diagram of FIG. 13 and according to the procedure diagram of FIG. 14.

The flowchart of FIG. 13, and the procedure diagram of FIG. 14 may depict an inference process for the data transmission following step 11-5, step 11-10, and step 11-15 of FIG. 11. Referring to the flowchart diagram of FIG. 13, the method for data transmission may include the following steps:

At step 13-1: A base station may initiate a data transmission to the WTRU.

At step 13-2: The WTRU may compute and update a BER metric.
In case the BER metric is above a preconfigured/predefined BER threshold, the WTRU may request a test TR-RS from the base station. Then go to step 13-6.
In case the BER metric is below the preconfigured/predefined BER threshold, then go to step 13-3.

At step 13-3: the WTRU may send a CSI report to the base station including measurement such as a received signal strength indication (RSSI), and a CQI.

At step 13-4: the base station may adopt a MCS based on the received CSI Report as part of the link level adaptation mechanism.

At step 13-5: the base station may compute and update the TBDR metric.
In case the TBDR metric is above a predefined TBDR threshold, then go to step 13-6.
In case the TBDR metric is below the predefined TBDR threshold, data transmission may continue. Then go to step 13-1.

At step 13-6: the base station may send test TR-RS to the WTRU to test the validity of the learned WTRU specific constellation.

At step 13-7: the WTRU may compute the loss and may send the loss value in TQI as part of the CSI Report to the base station.

At step 13-8: the base station may receive the TQI.
In case the loss in the TQI is below a predefined TQI threshold, data transmission continues. Then go to step 13-1.
In case the loss in the TQI is above the predefined TQI threshold, the base station may start the online training procedure for the symbol modulator/demodulator NN as shown from step 11-6 to step 11-15 of FIG. 11.

FIG. 14 depicts an example of a procedure diagram for data transmission using data-driven constellation shaper trained for WTRU specific symbol modulation.

At step 14-1, prior to data transmission, the base station and the WTRU may process a symbol modulation training that enables adaptive symbol constellation diagrams and modulation mapping at the base station and at the WTRU.

At step 14-2, the base station may transmit data to the WTRU based on the (pre)trained symbol modulator NN. The WTRU may (e.g., continuously) compute a BER metric upon receiving data form the base station.

At step 14-3, the base station may adopt a MCS based on the received CSI Report as part of the link level adaptation mechanism. The CSI report from the WTRU may include RSSI, and CQI. The WTRU may send a CSI report periodically or regularly to the base station.

At step 14-4 a test TR-RS decision may be processed. If the BER metric is above a preconfigured/predefined BER threshold, the WTRU may request a test TR-RS symbols from the base station. In that case, the base station may transmit a test TR-RS pilot signals including one or more test TR-RS symbols to the WTRU. The test TR-RS pilot signals may be sparse in the time domain, such that they may be transmitted in burst. The WTRU may compute loss upon receiving the test TR-RS symbols.

At step 14-5, the base station may decide to retrain the constellation based on a CSI report from the WTRU. The CSI report may include the loss within TQI wherein TQI is above a preconfigured/predefined TQI threshold.

At step 14-6, based on the retraining decision, the base station and the WTRU may (re)process a symbol modulation training.

### Downlink Control Information (DCI) Over PDCCH and Uplink Control Information (UCI) Over PUCCH Format-X for a Data Constellation Shaper.

According to various embodiments, systems and methods for the control and feedback messages for the data-driven constellation shaper are described below and may include the following steps:
The WTRU may receive a DCI including TR-RS information that comprises the scheduling of the TR-RS symbols.
In an option, the WTRU may descramble the DCI cyclic redundancy check (CRC) with a cell radio network temporary identifier (C-RNTI) to obtain the DCI content in a modified format.
In another option, the WTRU may descramble the DCI CRC with the a (e.g., new) training RNTI (TR-RNTI) to obtain the DCI content in a new format.
After receiving the TR-RS symbols, the WTRU may perform steps according to FIGS. 11 and 12, or according to FIGS. 13 and 14, and may start to send error value feedback as a new UCI content.

According to various embodiments, (e.g., new) signaling formats that enable the trained symbol modulator/demodulator autoencoder are described below.

### Examples DCI Configuration for TR-RS:

According to one embodiment, the DCI format 1_0 with CRC scrambled by C-RNTI as described in TS 38.212-7.3.1.2.1 may be modified in order to include the locations of TR-RS signals time-multiplexed with data, as illustrated, as a non-limited example, in Table 4.

TABLE 4
Example of (e.g., new) DCI format modified from DCI format
1_0 scrambled by C-RNTI (TS 38.212 - 7.3.1.2.1).

| Field | Bits | Reference |
|---|---|---|
| Identifier for DCI formats | 1 | Always 1 meaning for DL |
| Frequency domain resource assignment | Variable | ┌log₂(N_{RB}^{DL, BWP}(N_{RB}^{DL, BWP} + 1)/2)┐ |
| | | Indicates the start and length of a |
| | | set of contiguously allocated |
| | | resource blocks |
| | | N_{RB}^{DL, BWP} is the size of active bwp |
| Time domain resource assignment | 4 | Used to describe Start and |
| | | Length Indicator Value (SLIV) |
| | | of DL data |
| Time domain resource assignment for TR-RS | 4 | Used to describe SLIV of TR-RS |
| TR-RS type | 1 | 0: Test |
| | | 1: Training |
| VRB-to-PRB mapping | 1 | 0: Non-Interleaved |
| | | 1: Inverleaved |
| Modulation and coding scheme | 5 | Tables 5.1.3.1 in 38.214 |
| New data indicator | 1 | |
| Redundancy version | 2 | Table 7.3.1.1.1-2 in 38.212 |
| HARQ process number | 4 | |
| Downlink assignment index | 2 | Clause 9.1.3 TS38.213 |
| TPC command for scheduled PUCCH | 2 | Clause 7.2.1 TS38.213 |
| PUCCH resource indicator | 3 | |
| PDSCH-to-HARQ_feedback timing indicator | 3 | K1 = {1, 2, . . . , 8} Clause 9.2.3 |
| | | TS38.213 |

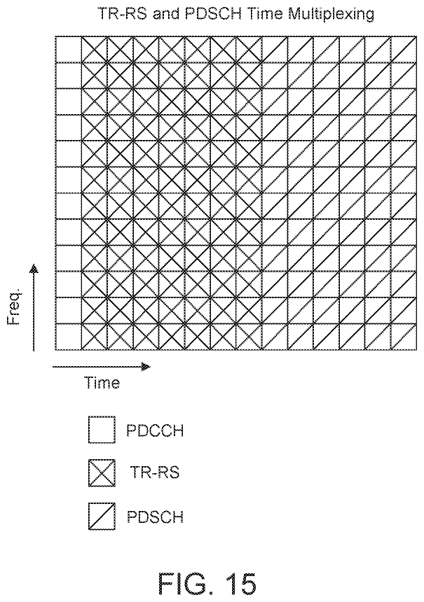

The fields ‘Time domain resource assignment for TR-RS’ and ‘TR-RS type’ have been incorporated in the DCI format 1_0 scrambled by C-RNTI (TS 38.212-7.3.1.2.1). The field ‘Time domain resource assignment for TR-RS’ may be used to describe a start and a length indicator value of the TR-RS. Said field may be coded by 4 bits. The field ‘TR-RS type’ may be coded on one bit, such that a bit value ‘0’ may indicate a test mode, and a bit value ‘1’ may indicate a training mode. According to FIG. 15, the DCI format of Table 4, may be used for time-domain multiplexing of data and TR-RS. FIG. 15 illustrates an exemplary TR-RS and PDSCH time multiplexing. Other DCI format types may include TR-RS related configuration.

According to one embodiment, the DCI format 10 with CRC scrambled by C-RNTI as described in TS 38.212-7.3.1.2.1 may be modified in order to include the locations of TR-RS signals frequency-multiplexed with data, as illustrated, as a non-limited example, in Table 5.

TABLE 5
Example of (e.g., new) DCI format modified from DCI format
1_0 scrambled by C-RNTI (TS 38.212 - 7.3.1.2.1).

| Field | Bits | Reference |
|---|---|---|
| Identifier for DCI formats | 1 | Always 1 meaning for DL |
| Frequency domain resource assignment | Variable | ┌log₂(N_{RB}^{DL, BWP}(N_{RB}^{DL, BWP} + 1)/2)┐ |
| | | Indicates the start and length of a |
| | | set of contiguously allocated |
| | | resource blocks |
| | | N_{RB}^{DL, BWP} |
| | | is the size of active bwp |
| Time domain resource assignment | 4 | Used to describe SLIV of DL data |
| Frequency domain resource assignment for TR-RS | Variable | ┌log₂(N_{RB}^{DL, BWP}(N_{RR}^{DL, BWP} + 1)/2)┐ |
| | | Indicates the start and length of a |
| | | set of contiguously allocated |
| | | resource blocks |
| | | N_{RB}^{DL, BWP} is the size of active bwp |
| TR-RS type | 1 | 0: Test |
| | | 1: Training |
| VRB-to-PRB mapping | 1 | 0: Non-Interleaved |
| | | 1: Inverleaved |
| Modulation and coding scheme | 5 | Tables 5.1.3.1 in 38.214 |
| New data indicator | 1 | |
| Redundancy version | 2 | Table 7.3.1.1.1-2 in 38.212 |
| HARQ process number | 4 | |
| Downlink assignment index | 2 | Clause 9.1.3 TS38.213 |
| TPC command for scheduled PUCCH | 2 | Clause 7.2.1 TS38.213 |
| PUCCH resource indicator | 3 | |
| PDSCH-to-HARQ_feedback timing indicator | 3 | K1 = {1, 2, . . . , 8} Clause 9.2.3 |
| | | TS38.213 |

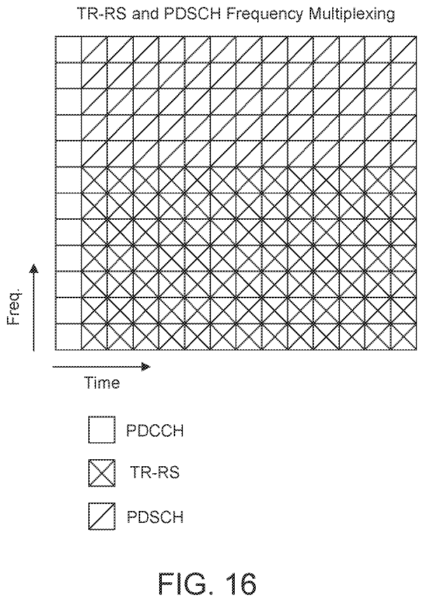

The fields ‘Frequency domain resource assignment for TR-RS’ and ‘TR-RS type’ have been incorporated in the DCI format 1_0 scrambled by C-RNTI (TS 38.212-7.3.1.2.1). The field Frequency domain resource assignment for TR-RS may be used to indicate the start and length of a set of contiguously allocated resource blocks. Said field may be coded by a variable number of bits. The field ‘TR-RS type’ may be coded on one bit, such that a bit value ‘0’ may indicate a test mode, and a bit value ‘1’ may indicate a training mode. According to FIG. 16, the DCI format of Table 5, may be used for frequency-domain multiplexing of data and TR-RS. FIG. 16 illustrates an exemplary TR-RS and PDSCH frequency multiplexing. Other DCI format types may include TR-RS related configuration.

According to one embodiment, the DCI format 1_0 with CRC scrambled by C-RNTI as described in TS 38.212-7.3.1.2.1 may be modified in order to include the locations of TR-RS signals time and frequency-multiplexed with data, as illustrated, as a non-limited example, in Table 6.

TABLE 6
Example of (e.g., new) DCI format modified from DCI format
1_0 scrambled by C-RNTI (TS 38.212 - 7.3.1.2.1).

| Field | Bits | Reference |
|---|---|---|
| Identifier for DCI formats | 1 | Always 1 meaning for DL |
| Frequency domain resource assignment | Variable | ┌log₂(N_{RB}^{DL, BWP}(N_{RB}^{DL, BWP} + 1)/2)┐ |
| | | Indicates the start and length of a |
| | | set of contiguously allocated |
| | | resource blocks |
| | | N_{RB}^{DL, BWP} |
| | | is the size of active bwp |
| Time domain resource assignment | 4 | Used to describe SLIV of DL |
| | | data |
| Frequency domain resource assignment for TR-RS | Variable | ┌log₂(N_{RB}^{DL, BWP}(N_{RB}^{DL, BWP} + 1)/2)┐ |
| | | Indicates the start and length of a |
| | | set of contiguously allocated |
| | | resource blocks |
| | | N_{RB}^{DL, BWP} |
| | | is the size of active bwp |
| Time domain resource assignment for TR-RS | 4 | Used to describe SLIV of TR-RS |
| TR-RS type | 1 | 0: Test |
| | | 1: Training |
| VRB-to-PRB mapping | 1 | 0: Non-Interleaved |
| | | 1: Inverleaved |
| Modulation and coding scheme | 5 | Tables 5.1.3.1 in 38.214 |
| New data indicator | 1 | |
| Redundancy version | 2 | Table 7.3.1.1.1-2 in 38.212 |
| HARQ process number | 4 | |
| Downlink assignment index | 2 | Clause 9.1.3 TS38.213 |
| TPC command for scheduled PUCCH | 2 | Clause 7.2.1 TS38.213 |
| PUCCH resource indicator | 3 | |
| PDSCH-to-HARQ_feedback timing indicator | 3 | K1 = {1, 2, . . . , 8} Clause 9.2.3 |
| | | TS38.213 |

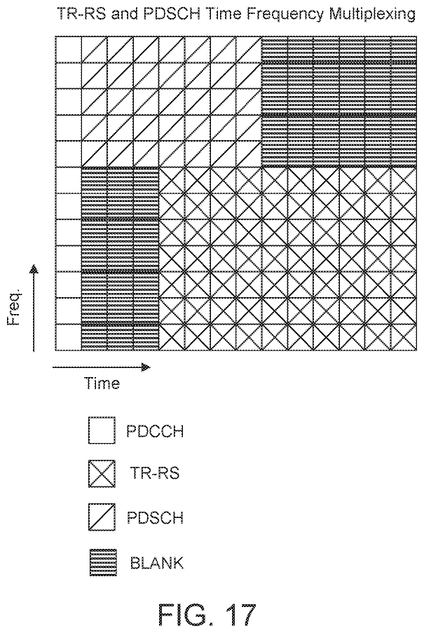

The fields ‘Frequency domain resource assignment for TR-RS’, ‘Time domain resource assignment for TR-RS’ and ‘TR-RS type’ have been incorporated in the DCI format 1_0 scrambled by C-RNTI (TS 38.212-7.3.1.2.1). The field ‘Frequency domain resource assignment for TR-RS’ may be used to indicate the start and length of a set of contiguously allocated resource blocks. Said field may be coded by a variable number of bits. The field ‘Time domain resource assignment for TR-RS’ may be used to describe a start and a length indicator value of the TR-RS. Said field may be coded by 4 bits. The field ‘TR-RS type’ may be coded on one bit, such that a bit value ‘0’ may indicate a test mode, and a bit value ‘1’ may indicate a training mode. According to FIG. 17, the DCI format of Table 6, may be used for time and frequency-domain multiplexing of data and TR-RS. FIG. 17 illustrates an exemplary TR-RS and PDSCH time frequency multiplexing. The type of active DCI type (either time multiplexing, frequency multiplexing or time-frequency multiplexing) may be signalled to the WTRU via radio resource control, RRC, messaging.

Many fields in this DCI format may not be needed in the case where only TR-RS are sent in a slot. To cover this scenario, as another embodiment, new DCI format 1_0 with CRC scrambled by new TR-RNTI may be used, as illustrated, as a non-limited example, in Table 7.

TABLE 7
Example of (e.g., new) DCI format modified from DCI format
1_0 scrambled by TR-RNTI (TS 38.212 - 7.3.1.2.1).

| Field | Bits | Reference |
|---|---|---|
| Frequency domain resource assignment for | Variable | ┌log₂(N_{RB}^{DL, BWP}(N_{RB}^{DL, BWP} + 1)/2)┐ |
| TR-RS | | Indicates the start and length of a |
| | | set of contiguously allocated |
| | | resource blocks |
| | | N_{RB}^{DL, BWP} |
| | | is the size of active bwp |
| Time domain resource assignment for TR-RS | 4 | Used to describe SLIV of TR-RS |
| TR-RS type | 1 | 0: Test |
| | | 1: Training |

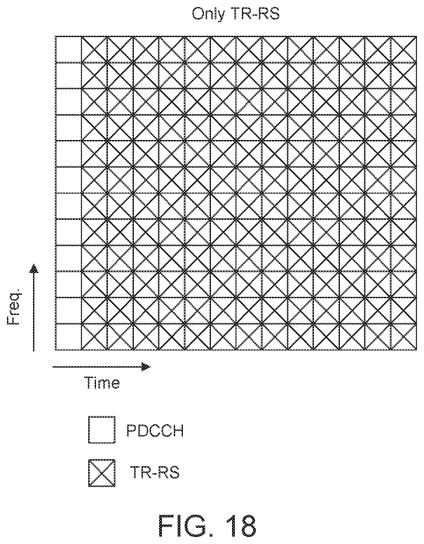

This DCI format may be used when the slot may be scheduled with TR-RS only. This DCI format may be used for time and frequency-domain multiplexing of data and TR-RS, as given in exemplary FIG. 18

Sending the TR-RS configuration over DCI may allow for semipersistent and aperiodic TR-RS transmission. MAC CE may be used to configure the WTRU for both semi-persistent and periodic TR-RS reception.

Existing reference signal such as DM-RS, CSI-RS and PT-RS may follow the structures defined in documents 3GPP TS 38.211, TS 38.212, TS 38.213. TR-RS allocated time-frequency resources may not include other reference signals.

TR-RS density may be higher compared to exiting reference signals such as DM-RS and TR-RS. Continuous TR-RS allocations in FIG. 16-18 may be due to high density.

### Example TR-RNTI Configuration:

TR-RNTI may be defined as a new RNTI value in 38.321 7.1. As an example, the hexa-decimal value of TR-RNTI can be chosen to be between 0001-FFF2. The new RNTI may be used for the transport channel: downlink shared channel (DL-SCH) and for the logical channel: dedicated traffic channel (DTCH).

### Example UCI Configuration for Error Value Feedback:

Existing PUCCH formats that may support up to 14 symbols over 16 physical resource blocks (PRBs) [9.2.1 TS 38.213] may not be sufficient to carry the large bitwidth of error value feedback. A new extended PUCCH Format-X may be defined which may extend to any number of PRBs. The bitwidth of the new UCI field to carry the error value feedback may be determined based on the number of TR-RS symbols, which is inherently signalled with the new DCI that includes the time-frequency allocation of TR-RS in PDCCH. Hence, the number of TR-RS symbols as well as quantization level may be known to both base station and WTRU. The total number of resource elements in PDCCH dedicated to TR-RS may be equal to the number of TR-RS. For example, if N_{TR}=120, and 32 bits of quantization is used, then this will correspond to 2·N_{TR}·32=7680 bits before channel coding. In order to support the high number of bits per UCI, the number of code blocks C defined in 5.2.1 TS 38.212 may take values larger than 2. Based on this, the number of code blocks C may be defined as C=┌A/Aₘₐₓ┐, where Aₘₐₓ may denote the maximum bits per code block as defined in 6.3.1.2.1 TS 38.212.

According to an embodiment, a method implemented in a WTRU, for training modulation and coding scheme, may comprise the following steps. At a first step, the WTRU may receive information from a base station, wherein the information may comprise an index from a neural network codebook indicating an adaptive modulation scheme. The index is one of a neural network parameter. At a next step, the WTRU may initialize its demodulator block, e.g., its neural network, based on the received index. At another step, the WTRU may receive one or more training reference signals from the base station. The base station may have sent the index and the training reference signals via one or more messages. At another step, the WTRU may update the parameters of the demodulator block (e.g., the parameters of the neural network), and the WTR may compute a training quality indicator value based on training convergence and loss. Ten, at a next step, the WRU may transmit to the base station, the training quality indicators and error values. At a next step, the WTRU may resume the training reference signals reception to continue training or to continue receiving information from the base station to switch to fixed modulation scheme.

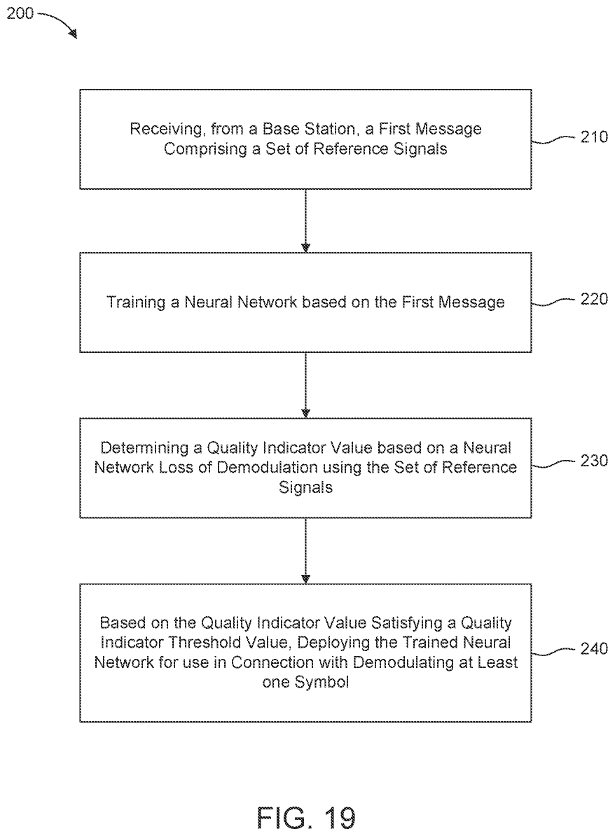

Referring to FIG. 19, and according to an embodiment, a method 200, implemented in a WTRU may comprise a step of receiving 210, from a base station or from another WTRU, a first message comprising a set of reference signals. The method 200, may comprise a step of training 220 a neural network based on the first message, more particularly, based on the set of reference signals.

It has to be noted that the neural network may have been initialized according to one or more neural network parameters received from the base station (e.g., neural network index from a neural network codebook). The neural network parameters may have been received by the WTRU via a message transmitted from the base station such that the WTRU may have received one or more messages comprising information indicating the one or more neural network parameters and the set of reference signals. Accordingly, the WTRU may initialize and train a neural network based on the one or more messages.

The method 200, may comprise a step of determining 230 a quality indicator value based on a neural network loss of demodulation wherein the neural network loss of demodulation is based on the demodulation loss using the set of reference signals.

The method 200 may comprise a step of, based on the fact that the quality indicator value is satisfying a quality indicator threshold value, deploying 240 the trained neural network for use in connection with demodulating at least one symbol.

In case of the quality indicator value is failing to satisfy the quality indicator threshold value, the WTRU may utilize any of conventional modulation and coding scheme (MCS) and an alternative MCS.

According to the method 200, deploying the trained neural network for use in connection with demodulating at least one symbol may comprise predicting a modulation and coding scheme (MCS) or predicting a constellation.

According to the method 200, in response to or for as long as, one or more subsequently computed quality indicator values fail to satisfy the quality indicator threshold, the WTRU may re-train the trained neural network wherein the step of re-training the trained neural network may comprise the steps of: receiving, from the base station, a second message comprising another set of reference signals; re-training the trained neural network based on the second message; and computing another quality indicator value based on another neural network loss of demodulation using the other set of reference signals. The WTRU may compute error values for one or more nodes of the re-trained neural network; and the WTRU may transmit, to the base station, a third message comprising information indicating error values for the one or more nodes of the re-trained neural network. The WTRU may receive, from the base station, a fourth message comprising information indicating a maximum number of iterations for re-training the trained neural network such that the WTRU may re-train the trained neural network up to the maximum number of iterations. On condition that the maximum number of iterations is exceeded and a quality indicator value fails to satisfy the quality indicator threshold value, the WTRU may deploy any of a conventional MCS and an alternative MCS.

According to the method 200, training (e.g., re-training) the neural network may comprise updating one or more neural network parameters based on the set of reference signals. Updating the one or more neural network parameters may comprise computing any of one or more neural network output loss values and one or more neural network output error values for one or more nodes in the trained neural network based on the set of reference signals.

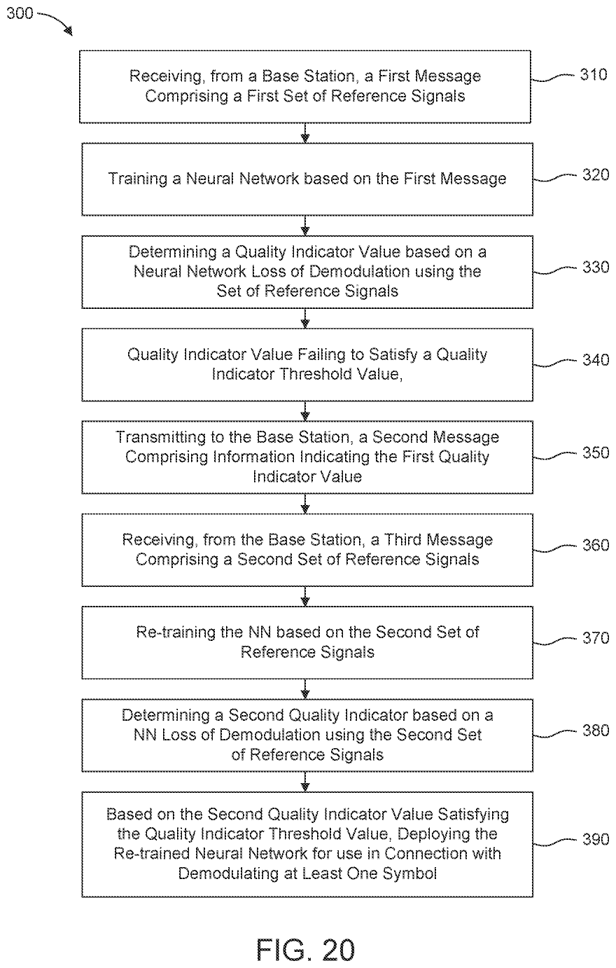

Referring to FIG. 20, and according to an embodiment, a method 300, implemented in a WTRU may comprise a step of receiving 310, from a base station or from another WTRU, a first message comprising a first set of reference signals. The method 300, may comprise a step of training 220 a neural network based on the first message, more particularly, based on the first set of reference signals.

It has to be noted that the neural network may have been initialized according to one or more neural network parameters received from the base station (e.g., neural network index from a neural network codebook). The neural network parameters may have been received by the WTRU via a message transmitted from the base station such that the WTRU may have received one or more messages comprising information indicating the one or more neural network parameters and the first set of reference signals. Accordingly, the WTRYU may initialize and train a neural network based on the one or more messages.

The method 300, may comprise a step of determining 330 a quality indicator value based on a neural network loss of demodulation wherein the neural network loss of demodulation is based on the demodulation loss using the set of reference signals.

The method 300 may comprise the following steps, based on the fact that the quality indicator value is failing to satisfy 340 a quality indicator threshold value. The method 300 may comprise a step of transmitting 350 to the base station or to the other WTRU, a second message comprising information indicating the first quality indicator value. According to the next step of the method 300, the WTRU may receive 360, from the base station or from the other WTRU, a third message comprising a second set of reference signals. Accordingly, the method 300 may comprise a step of re-training 370 the neural network based on the second set of reference signals. According to the next step, the method may comprise a step of determining 380 a second quality indicator based on a neural network loss of demodulation using the second set of reference signals. According to the next step and based on the fact that the second quality indicator value is satisfying the quality indicator threshold value, the method 300 may comprise a step of deploying 390 the re-trained neural network for use in connection with demodulating at least one symbol

### CONCLUSION

Although features and elements are provided above in particular combinations, one of ordinary skill in the art will appreciate that each feature or element can be used alone or in any combination with the other features and elements. The present disclosure is not to be limited in terms of the embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method, implemented in a wireless transmit and receive unit (WTRU), the method comprising:
receiving, from a base station, a first message comprising a set of reference signals;
training a neural network based on the first message;
determining a quality indicator value based on a neural network loss of demodulation using the set of reference signals; and
based on the quality indicator value satisfying a quality indicator threshold value, deploying the trained neural network for use in connection with demodulating at least one symbol, wherein deploying the trained neural network for use in connection with demodulating at least one symbol comprises predicting a modulation and coding scheme (MCS).

2. The method of claim 1, further comprising:
based on the quality indicator value failing to satisfy the quality indicator threshold value, utilizing any of conventional modulation and coding scheme (MCS) and an alternative MCS.

3-4. (canceled)

5. The method of claim 1, further comprising:
in response to or for as long as, one or more subsequently computed quality indicator values fail to satisfy the quality indicator threshold, re-training the trained neural network.

6. The method of claim 5, wherein re-training the trained neural network comprises:
receiving, from the base station, a second message comprising another set of reference signals;
re-training the trained neural network based on the second message; and
computing another quality indicator value based on another neural network loss of demodulation using the other set of reference signals.

7. The method of claim 5, further comprising:
computing error values for one or more nodes of the re-trained neural network; and
transmitting, to the base station, a third message comprising information indicating error values for the one or more nodes of the re-trained neural network.

8. The method of claim 5, further comprising:
receiving, from the base station, a fourth message comprising information indicating a maximum number of iterations for re-training the trained neural network, wherein re-training the trained neural network comprises re-training the trained neural network up to the maximum number of iterations.

9. The method of claim 8, further comprising:
on condition that maximum number of iterations is exceeded and a quality indicator value fails to satisfy the quality indicator threshold value, deploying any of a conventional MCS and an alternative MCS.

10. The method of claim 1, wherein training the neural network comprises updating one or more neural network parameters based on the set of reference signals.

11. The method of claim 8, wherein updating the one or more neural network parameters comprises computing any of one or more neural network output loss values and one or more neural network output error values for one or more nodes in the trained neural network based on the set of reference signals.

12. A method, implemented in a wireless transmit and receive unit (WTRU), the method comprising:
receiving, from a base station, a first message comprising a first set of reference signals;
training a neural network, NN, based on the first message;
determining a first quality indicator value based on a neural network loss of demodulation using the first set of reference signals;
based on the first quality indicator value failing to satisfy a quality indicator threshold value:
transmitting to the base station, a second message comprising information indicating the first quality indicator value,
receiving, from the base station, a third message comprising a second set of reference signals, and
re-training the NN based on the second set of reference signals;
determining a second quality indicator based on a NN loss of demodulation using the second set of reference signals; and
based on the second quality indicator value satisfying the quality indicator threshold value, deploying the re-trained neural network for use in connection with demodulating at least one symbol.

13. A wireless transmit and receive unit (WTRU), comprising any of a processor and memory, configured to:
receive, from a base station, a first message comprising a set of reference signals;
train a neural network based on the first message;
determine a quality indicator value based on a neural network loss of demodulation using the set of reference signals; and
based on the quality indicator value satisfying a quality indicator threshold value, deploy the trained neural network for use in connection with demodulating at least one symbol, wherein deploy the trained neural network for use in connection with demodulating at least one symbol comprises predict a modulation and coding scheme (MCS).

14. The WTRU of claim 13, configured to:
based on the quality indicator value failing to satisfy the quality indicator threshold value, utilize any of conventional modulation and coding scheme (MCS) and an alternative MCS.

15. (canceled)

16. The WTRU of claim 13, configured to:
in response to or for as long as, one or more subsequently computed quality indicator values fail to satisfy the quality indicator threshold, re-train the trained neural network.

17. The WTRU of claim 16, wherein re-train the trained neural network comprises:
receive, from the base station, a second message comprising another set of reference signals;
re-train the trained neural network based on the second message; and
compute another quality indicator value based on another neural network loss of demodulation using the other set of reference signals.

18. The WTRU of claim 16, further configured to:
compute error values for one or more nodes of the re-trained neural network; and
transmit, to the base station, a third message comprising information indicating error values for the one or more nodes of the re-trained neural network.

19. (canceled)

20. The WTRU of claim 16, configured to:
receive, from the base station, a fourth message comprising information indicating a maximum number of iterations for re-training the trained neural network, wherein re-train the trained neural network comprises re-train the trained neural network up to the maximum number of iterations.

21. The WTRU of claim 20, configured to deploy any of a conventional MCS and an alternative MCS, on condition that maximum number of iterations is exceeded and a quality indicator value fails to satisfy the quality indicator threshold value.

22. The WTRU of claim 13, wherein train the neural network comprises update one or more neural network parameters based on the set of reference signals.

23. The WTRU of claim 22, wherein update the one or more neural network parameters comprises compute any of one or more neural network output loss values and one or more neural network output error values for one or more nodes in the trained neural network based on the set of reference signals.
